(19) United States
(12) Patent Application Publication
(10) Pub. No.: US 2016/0102235 A1
(43) Pub. Date: Apr. 14, 2016

(54) Phase-Transition-Based Thermal Conductivity in Anti-Ferroelectric Materials

(71) Applicants: Patrick Edward Hopkins, Charlottesville, VA (US); Sandia Corporation, Albuquerque, NM (US)

(72) Inventors: Jon Ihlefeld, Albuquerque, NM (US); Patrick Edward Hopkins, Charlottesville, VA (US)

(21) Appl. No.: 14/973,977

(22) Filed: Dec. 18, 2015

Related U.S. Application Data
(63) Continuation-in-part of application No. 14/546,147, filed on Nov. 18, 2014, now Pat. No. 9,255,347.
(60) Provisional application No. 61/907,804, filed on Nov. 22, 2013.

(51) Int. Cl. C09K 5/14; C01G 33/00

(52) U.S. Cl. CPC C09K 5/14; C01G 33/00

(57) ABSTRACT

Thermal conductivity can be altered by applying an electric field to an antiferroelectric material or a pressure to a ferroelectric material, thereby inducing a phase transition. The materials have compositions close to a phase boundary separating the ferroelectric and antiferroelectric phases, such as PbZr₁₋ₓTiₓO₃ (with x≦0.08), Pb(NbₓZr_{y}Sn_{z}Ti_{1-y-z})O₃, (Pb,La)(Zr_{y}Sn_{z}Ti_{1-y-z})O₃, NaNbO₃, Bi_{0.5}Na_{0.5}TiO₃, or AgNbO₃. By inducing a phase transition using either an electric field or pressure, the resulting change in the thermal conductivity can be used to provide a thermal switch or a continuous thermal conductivity tuning element.

### CROSS-REFERENCE TO RELATED APPLICATION

This application is a continuation-in-part of U.S. application Ser. No. 14/546,147, filed Nov. 18, 2014, which claims the benefit of U.S. Provisional Application No. 61/907,804, filed Nov. 22, 2013, both of which are incorporated herein by reference.

### STATEMENT OF GOVERNMENT INTEREST

This invention was made with Government support under contract no. DE-AC04-94AL85000 awarded by the U.S. Department of Energy to Sandia Corporation. The Government has certain rights in the invention.

### FIELD OF THE INVENTION

The present invention relates to thermal conductivity in solid state materials and, in particular, to a method for phase-transition-based thermal conductivity in anti-ferroelectric materials.

### BACKGROUND OF THE INVENTION

Thermal energy transport across interfaces is a topic of great recent interest. Largely this resurgence is motivated by a necessity to control heat generated in microelectronics and to develop new higher-performance thermoelectric materials for cooling applications and energy harvesting. The interfaces in these materials, however, are static and immobile without gross material deformation. Separately, there has been a need for appropriate materials or nanosystems where thermal conductivity can be actively altered or rectified. Typically this is provided by mechanical means (physical separation) or through the use of one-dimensional materials (nanowires) that can only carry minute amounts of thermal energy.

It is well known that as material characteristic dimension (thickness, grain size, etc.) scales toward nanometer length scales, the role of interfaces on thermal transport become increasingly important. This phenomenon is driven largely by the fact that the bulk of heat is carried by phonons with mean free paths of 1-100 nm. See D. G. Cahill et al., J. Appl. Phys. 93, 793 (2003). Therefore, as material dimensions approach these length scales, they become comparable to the phonon wavelengths. This trend has fueled a substantial recent increase in studies into preparation of thermoelectric materials with fine grain sizes and superlattice structures where a high density of incoherent, highly disordered interfaces has been shown to scatter phonons and decrease thermal conductance. See Z. J. Wang et al., Nano Lett. 11, 2206 (2011); S. K. Bux et al., Adv. Fund. Mater. 19, 2445 (2009); G. Joshi et al., Nano Lett. 8, 4670 (2008); B. Poudel et al., Science 320, 634 (2008); W. J. Xie et al., Appl. Phys. Lett. 94, 102111 (2009); Y. C. Lan et al., Adv. Fund. Mater. 20, 357 (2010); W. S. Capinski et al., Phys. Rev. B 59, 8105 (1999); R. Venkatasubramanian et al., Nature 413, 597 (2001); and S. M. Lee et al., Appl. Phys. Lett. 70, 2957 (1997).

Ferroelectric materials display a spontaneous polarization that can be reversed by the application of an external electric field. The linkage of ferroelectricity and phonon dispersion is well documented. It is the condensation of a transverse optical “soft” phonon mode that results in the stabilization of the dipole moment that gives rise to the reorientable polarization that is the hallmark of ferroelectric response. As described in U.S. application Ser. No. 14/546,147, thermal conductivity can be controlled by applying an electric field to a ferroelectric material. Application of an electric field alters the domain structure and domain wall density in the ferroelectric material. Domain boundaries are coherent interfaces in ferroelectric materials separating regions of differing polarization. Domain boundaries are effective phonon scattering sites in the ferroelectric material and their existence can substantially reduce the thermal conductivity of ferroelectric materials. Therefore, thermal conductivity can be modified by supplying a sufficient electric field to alter the domain structure. For example, if an electric field is applied, these domain boundaries can be swept away from the area under the electrode and increase the thermal conductivity. Alternatively, the domain boundary density can increase when an electric field is applied, thereby decreasing the thermal conductivity. Voltage tunability of thermal conductivity should be possible to some degree in all ferroelectric materials where domain walls can be altered by external stimuli (electric fields, strain, or temperature change).

As an example, FIG. 1A shows an epitaxial ferroelectric film 11 grown on a substrate 12. In this example, the epitaxial ferroelectric film 11 has two domain variants 13 and 14 (i.e., two polarization directions, as indicated by the orthogonal heavy arrows and stippling). The epitaxial ferroelectric film can be prepared with epitaxial conductive oxide or metal electrodes 15 and 16 to enable an electrical field to be applied to the thin film structure 11. For time domain thermoreflectance (TDTR) measurements, a pump laser pulse 17 can be applied to the top electrode 16 to excite phonons 18 in the film 11. These phonons 18 will be scattered 19 at domain boundaries. As shown in FIG. 1B, under the application of a sufficient electric field E=V/t, a finite fraction of the domain boundaries will be swept through the ferroelectric material 11, resulting in an overall reduction of the total domain wall concentration within the area where the field has been applied. By reducing the total number of domain boundaries in this region, the amount of phonon scattering 19 by these domain walls can be reduced and the overall thermal conductivity can be increased. Alternatively, application of the electric field can increase the domain wall density, resulting in a decrease in thermal conductivity in some ferroelectric materials.

As an example, a repeatable modulation of the room temperature thermal conductivity of a ferroelectric thin film, Pb(Zr_{0.3}Ti_{0.7})O₃, with the application of an electric field was demonstrated. This effect arises from control of the nanoscale ferroelastic domain boundary density under an applied field, which leads to an increased scattering of heat-carrying phonons. FIG. 2A shows the field dependence of thermal conductivity for a bilayer film comprising a tetragonal symmetry PZT layer (PbZr_{0.3}Ti_{0.7}O₃) on top of a rhombohedral symmetry PZT layer (PbZr_{0.7}Ti_{0.3}O₃). The thermal conductivity decreases by 11% from the unpoled, virgin state under an applied field of 460 kV/cm. Upon removal of the applied field, it was found that the thermal conductivity did not recover fully to its original value, but that the thermal conductivity in the remanent poled, ferroelectric state was ˜2.7% less than that in the unpoled state. To better understand the speed and reproducibility of the field-induced thermal conductivity change, the thermoreflectivity of the top electrode was monitored at a fixed pump-probe delay time of 150 ps while cycling the applied DC field across the sample between 0 and 460 kV/cm (0 and 10 V). FIG. 2B shows the time dependence of the thermal conductivity while cycling the DC field. A nearly instantaneous decrease (less than 300 ms, limited by the integration time of the lock-in amplifier) was observed in the thermal conductivity when the field was applied, which recovered when the field was removed. The tuning effect is reversible, polarity independent, and occurs on the time scale of ferroelastic domain wall nucleation and growth (sub-second), with theoretical response speeds in the nanosecond time frame.

### SUMMARY OF THE INVENTION

The present invention is directed to a method to control thermal conductivity in an antiferroelectric material, comprising providing an antiferroelectric material and applying a sufficient electric field to the material to induce an antiferroelectric-to-ferroelectric phase change in the material, thereby altering the thermal conductivity of the material. The invention is further directed to a method to control thermal conductivity in a ferroelectric material, comprising providing a ferroelectric material and applying a sufficient pressure to the material to induce a ferroelectric-to-antiferroelectric phase change in the material, thereby altering the thermal conductivity of the material. The antiferroelectric or ferroelectric material can comprise PbZr₁₋ₓTiₓO₃ (with x≦0.08), Pb(NbₓZr_{y}Sn_{z}Ti_{1-y-z})O₃, (Pb,La)(Zr_{y}Sn_{z}Ti_{1-y-z})O₃, NaNbO₃, Bi_{0.5}Na_{0.5}TiO₃, or AgNbO₃. By inducing a phase transition using either an electric field or pressure, a change in the thermal conductivity or the material will occur and can be used to provide a thermal switch or a continuous thermal conductivity tuning element.

### BRIEF DESCRIPTION OF THE DRAWINGS

The detailed description will refer to the following drawings, wherein like elements are referred to by like numbers.

FIGS. 1A and 1B are schematic illustrations showing how an electric field can be used to alter the domain wall density in a ferroelectric film and affect phonon transport within the film.

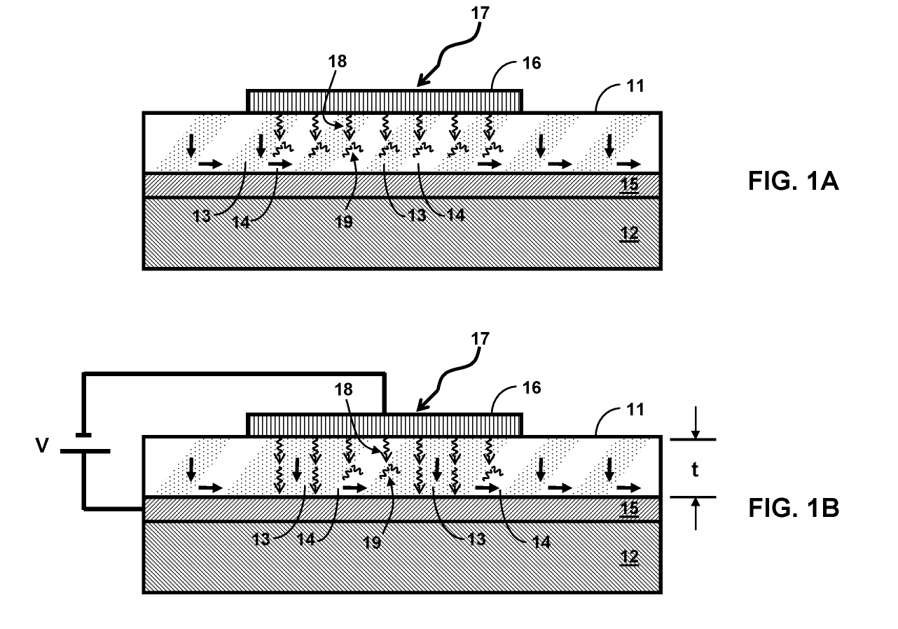

FIG. 2A is a graph of the DC electric field dependence of thermal conductivity in the PbZr_{0.3}Ti_{0.7}O₃ layer of the PZT bilayerfilm measured at room temperature. Also shown are the zero-field thermal conductivities of the initially unpoled material and those of the remanent poled material after application of positive and negative bias. FIG. 2B is a graph of the real-time change in thermal conductivity measured via time domain thermoreflectance (TDTR) at a delay time of 150 ps, showing the dynamic response of the thermal conductivity tuning effect.

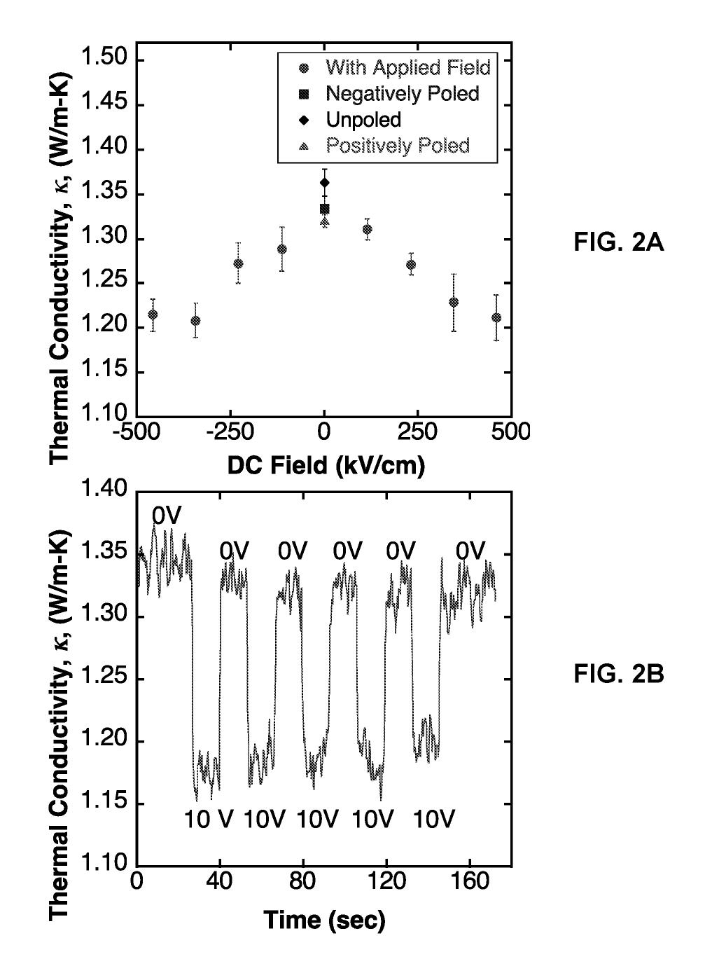

FIGS. 3A and 3B are schematic illustrations showing how an electric field can be used to induce an antiferroelectric-to-ferroelectric phase change in an antiferroelectric film and thereby affect phonon transport within the film.

### DETAILED DESCRIPTION OF THE INVENTION

A ferroelectric material displays a spontaneous electric polarization that can be reversed by the application of an external electric field. Therefore, all of the electric dipoles can point in the same direction, dependent upon the applied field. Conversely, an antiferroelectric material consists of an ordered (crystalline) array of electric dipoles, but with adjacent dipoles oriented in opposite (antiparallel) directions (the dipoles of each orientation form interpenetrating sublattices). In an antiferroelectric material, unlike a ferroelectric material, the total, macroscopic spontaneous polarization is zero, since the adjacent dipoles cancel each other out. When an antiferroelectric crystal is subjected to an electric field, the antiparallel dipoles can be flipped and forced to parallel, thereby inducing an antiferroelectric-to-ferroelectric phase transition with accompanying large increase in electric polarization and an abrupt volume expansion. Conversely, hydrostatic pressure is known to stabilize the antiferroelectric phase. Therefore, a ferroelectric-to-antiferroelectric phase transition can be induced when a hydrostatic pressure is applied to a ferroelectic material.

The present invention is directed to a method to control thermal conductivity by applying an electric field to an antiferroelectric material or a pressure to a ferroelectric material, thereby inducing a phase transition. The materials have compositions close to a phase boundary separating the ferroelectric and antiferroelectric phases. For example, the antiferroelectric and ferroelectric materials can be PbZr₁₋ₓTiₓO₃ (with x≦0.08), Pb(NbₓZr_{y}Sn_{z}Ti_{1-y-z})O₃, (Pb,La)(Zr_{y}Sn_{z}Ti_{1-y-z})O₃, NaNbO₃, Bi_{0.5}Na_{0.5}TiO₃, or AgNbO₃. Under the application of an applied electric field, these antiferroelectric materials can undergo a phase transition to a ferroelectric state. Likewise, under the application of pressure, these ferroelectric materials can undergo a phase transition to an antiferroelectric state. As described below, several mechanisms of altering the thermal conductivity through these phase transitions can occur.

Ferroelastic domain boundaries that are immobile in antiferroelectric phases suddenly become mobile in the ferroelectric phase, as described in U.S. application Ser. No. 14/546,147. These ferroelastic domain boundaries can scatter heat-carrying phonons. In the ferroelectric phase, because the domain boundaries are mobile, the number of the domain boundaries can increase or decrease depending on the mechanical boundary conditions of the material. If the ferroelectric material is undamped the number of ferroelastic domain boundaries will be reduced and phonon scattering will decrease. If the ferroelectric material is mechanically constrained, the number of ferroelastic domain boundaries can increase and phonon scattering will increase.

Upon transitioning between the antiferroelectric and ferroelectric phases, a change in the heat capacity of the material also occurs. A change in heat capacity can affect thermal conductivity due to changes in the phonon modes. There is also a volume expansion of the material upon transitioning from the antiferroelectric to ferroelectric phase. Increasing material volume affects both heat capacity and also phonon-phonon scattering. The thermal conductivity decreases upon increasing volume.

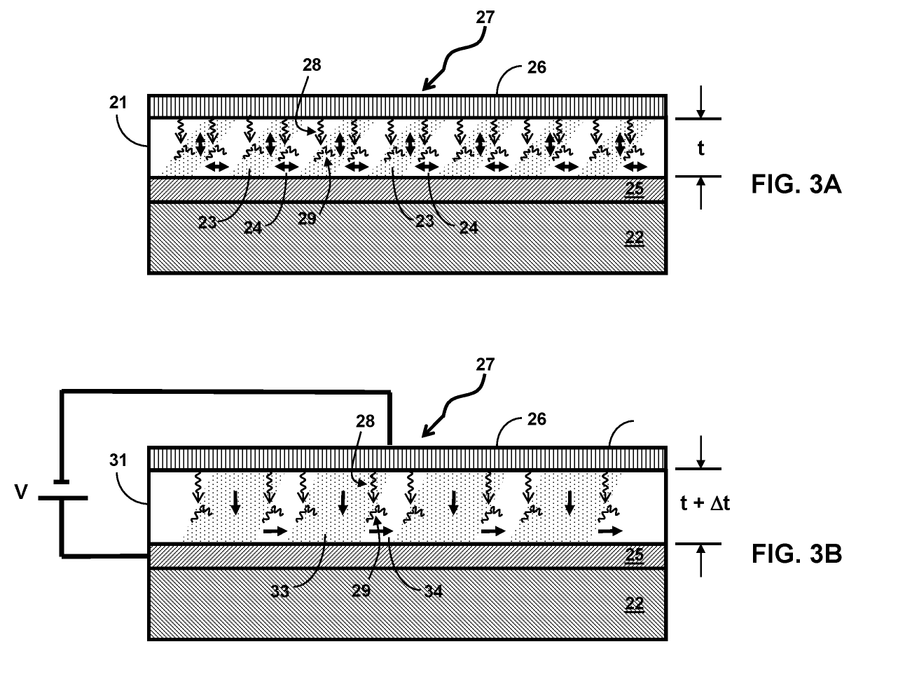

As an example, FIG. 3A shows an epitaxial antiferroelectric film 21 grown on a substrate 22. Alternatively, a bulk ceramic, polycrystalline, or single crystalline material can be used. In this example, the epitaxial antiferroelectric film 21 has two antiferroelectric domains 23 and 24. Within each domain, the net polarization is zero and the sublattices have antiparallel polarization directions denoted by the double-ended arrow. The boundary separating these domains is a ferroelastic domain wall. The epitaxial antiferroelectric film 21 can be prepared with epitaxial conductive oxide or metal electrodes 25 and 26 to enable an electrical field to be applied to the thin film structure 21. For time domain thermoreflectance (TDTR) measurements, a pump laser pulse 27 can be applied to the top electrode 26 to excite phonons 28 in the film 21. These phonons 28 will be scattered 29 at the ferroelastic domain boundaries. As shown in FIG. 3B, under the application of a sufficient electric field, the antiparallel dipoles are flipped and forced to parallel, thereby inducing an antiferroelectric-to-ferroelectric phase transition with accompanying large increase in electric polarization and an abrupt change in film thickness Δt. Further, a finite fraction of the resulting domain boundaries can be swept through the resulting ferroelectric material 31, resulting in an overall reduction of the total domain wall concentration within the area where the field has been applied. By transitioning the antiferroelectric phase 21 to a ferroelectric phase 31 and further reducing the total number of domain boundaries in the ferroelectric phase 31, the amount of phonon scattering 29 can be reduced and the overall thermal conductivity can be modified.

The present invention has been described as a phase-transition-based thermal conductivity in antiferroelectric materials. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method to control thermal conductivity in an antiferroelectric material, comprising:
providing an antiferroelectric material; and
applying a sufficient electric field to the material to induce an
antiferroelectric-to-ferroelectric phase change in the material, thereby altering the
thermal conductivity of the material.

2. The method of claim 1, wherein the antiferroelectric material comprises PbZr₁₋ₓTiₓO₃ (with x≦0.08), Pb(NbₓZr_{y}Sn_{z}Ti_{1-y-z})O₃, (Pb,La)(Zr_{y}Sn_{z}Ti_{1-y-z})O₃, NaNbO₃, Bi_{0.5}Na_{0.5}TiO₃, or AgNbO₃.

3. The method of claim 1, wherein the antiferroelectric material comprises an epitaxial film.

4. The method of claim 1, wherein the antiferroelectric material comprises a ceramic.

5. The method of claim 1, wherein the antiferroelectric material comprises a polycrystalline or single crystalline material.

6. A method to control thermal conductivity in a ferroelectric material, comprising:
providing a ferroelectric material; and
applying a sufficient pressure to the material to induce a ferroelectric-to-antiferroelectric phase change in the material, thereby altering the thermal conductivity of the material.

7. The method of claim 6, wherein the ferroelectric material comprises PbZr₁₋ₓTiₓO₃ (with x≦0.08), Pb(NbₓZr_{y}Sn_{z}Ti_{1-y-z})O₃, (Pb,La)(Zr_{y}Sn_{z}Ti_{1-y-z})O₃, NaNbO₃, Bi_{0.5}Na_{0.5}TiO₃, or AgNbO₃.

8. The method of claim 6, wherein the ferroelectric material comprises an epitaxial film.

9. The method of claim 6, wherein the ferroelectric material comprises a ceramic.

10. The method of claim 6, wherein the ferroelectric material comprises a polycrystalline or single crystalline material.
